(19) United States
(12) Patent Application Publication
(10) Pub. No.: US 2006/0052470 A1
(43) Pub. Date: Mar. 9, 2006

(54) Photopolymerizable composition based on an epoxyvinylester resin and on a urethane acrylate resin and use thereof for making dental prosthesis preforms and or models

(76) Inventors: Eric Grech, Tours (FR); Olivier Besnard, Veigne (FR); Bruno Lebret, Joue-Les -Tours (FR); Jacky Pennard, Veretz (FR); Franck Pennard, Veigne (FR)

Correspondence Address: FOLEY & LARDNER LLP, 1530 PAGE MILL ROAD, PALO ALTO, CA, 94304, US

(21) Appl. No.: 10/537,007

(22) PCT Filed: Jul. 15, 2004
(86) PCT No.: PCT/FR04/50333

§ 371 Date: May 26, 2005

(30) Foreign Application Priority Data
Jul. 16, 2003 (FR) 03 50334

(51) Int. Cl. C08F 2/50

(52) U.S. Cl. 522/6; 522/74

(57) ABSTRACT

The invention concerns a photopolymerizable composition comprising: at least one epoxyvinylester resin, at least one urethane acrylate resin, at least one organic silicon-free particulate filler having an average particle size less than 10 μm and a specific surface more than 10 m²/g, at least one photoinidator. Said composition is in particular useful for making dental prosthesis preforms and models.

### TECHNICAL FIELD

The present invention relates to photocurable compositions based on resins.

These compositions are intended in particular for the dental field, especially for preparing dental prosthesis preforms and/or patterns and more particularly still removable joined dental prosthesis patterns.

A joined dental prosthesis is a device intended to replace one or more teeth and their supporting tissues (bone and gum) which would be resorbed or more simply to restore a badly impaired tooth. Depending on whether the dental prosthesis can or cannot be put into place and removed by the patient, it is described as removable or fixed. These prostheses can be made of metals, synthetic resins or ceramics.

### STATE OF THE PRIOR ART

Generally, the preparation of a dental prosthesis, when it is a removable metal dental prosthesis, comprises the following steps:
a step of taking an impression, carried out by applying a rapid-setting material (such as alginates, an elastomer or a hydrocolloid) to the buccal part to be provided with a prosthesis, so as to obtain a reproduction in relief (“negative reproduction”) of said buccal part;
a step of preparing a model made of a material, for example plaster or a polyurethane resin (said model being commonly denoted by the terminology “master model”), consisting in pouring said material into the impression prepared above;
a further step of taking a gelatin or silicone impression by countermolding the preceding model;
a step of preparing an investment model by pouring investment material into the gelatin or silicone impression;
a step of preparing a wax pattern on the investment model;
a step of positioning the assembled product, composed of the pattern and of the model, in a cylinder, followed by investing said assembled product, so as to obtain an investment mold;
a step of calcining the wax in an oven;
a step of pouring a molten metal or metal alloy into the parts of the investment mold left vacant by the calcination of the wax pattern;
a step of destroying the investment mold, after solidification by cooling the metal or alloy, so as to release the prosthesis and to remove the investment model from the latter.

As clearly emerges from this paragraph, the preparation of a dental prosthesis, insofar as it comprises a large number of steps, proves to be very expensive and very lengthy.

Research has thus focused on the preparation of novel materials or novel compositions which would make it possible to facilitate the preparation of dental prosthesis, in particular by making it possible to reduce the number of steps necessary for the preparation of these prostheses.

In particular, photocurable compositions in the dental field have already been used as substances intended to participate in the preparation of dental prostheses.

Thus, in patent application EP 0 879 257 [1] , a curable composition comprising a cycloaliphatic epoxide resin, an inorganic filler and a curing initiator is disclosed. However, this composition has the disadvantage of exhibiting significant shrinkage during curing, which makes it rather unreliable for the preparation of patterns of appropriate dimensions. Due to the presence of an inorganic filler, this composition is also malleable with difficulty and cannot be completely calcined. Consequently, it cannot be substituted, as is the case with wax, by a cast or injected alloy.

U.S. Pat. 3,709,866 [2] also discloses a photocurable composition comprising an aromatic dimethacrylate resin or optionally an adduct of a diisocyanate with such a resin, a silicon-based vitreous filler and a photoinitiator initiator. This composition exhibits the disadvantage of being difficult to model, due in particular to the presence of the vitreous filler, and cannot be completely calcined.

The compositions disclosed in the prior art thus exhibit one or more of the following disadvantages:
they exhibit, after photocuring, a shrinkage of greater than 1%, which makes them rather unreliable for the preparation of patterns of appropriate dimensions;
they result in low levels of calcination, due in particular to the presence of an organic filler;
they do not lend themselves readily to modeling;
they have no shape memory, which would make it possible to obtain a faithful pattern, after removal of this pattern from its model;
they do not offer sufficient elasticity to produce a pattern which can be removed from its model without a detrimental change in shape.

### ACCOUNT OF THE INVENTION

The aim of the present invention is to provide novel compositions which do not exhibit the abovementioned disadvantages and which exhibit more particularly a shrinkage of less than 1% after photocuring, advantageous mechanical properties, such as a tensile strength ranging from 10 to 100 MPa and an elongation at break which can be approximately 5%, and a degree of calcination of 100%.

The abovementioned aim is achieved, in accordance with the invention, by a photocurable composition comprising:
at least one epoxy vinyl ester resin;
at least one urethane acrylate resin;
at least one non-silicone organic particulate filler exhibiting a mean particle size of less than 10 μm and a specific surface of greater than 10 m²/g; and
at least one photoinitiator.

The combination of the components participating in the abovementioned composition results in a composition existing in the form of a paste exhibiting the following characteristics:
a reduction in shrinkage on curing, in comparison with compositions of the prior art, this being by virtue in particular of the combination in the composition of the invention of at least one epoxy vinyl ester resin and of at least one urethane acrylate resin;
high stiffness, making it possible to obtain tensile strengths of 10 to 100 MPa;
sufficient elasticity to confer, on the composition, the final properties desired, namely an elongation at break which can be approximately 5%;
a ready ability to be shaped, due in particular to the presence of an organic filler exhibiting the abovementioned specific characteristics.

As mentioned above, the composition of the invention comprises at least one epoxy vinyl ester resin.

According to the invention, the term “epoxy vinyl ester resin” is understood to mean, previously and subsequently, a resin resulting from the addition of an acrylic or methacrylic acid to an epoxy resin.

According to the invention, advantageous epoxy vinyl ester resins can correspond to the following general formula: 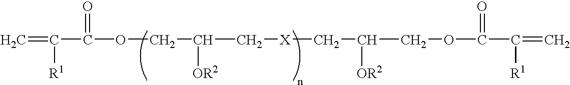
in which:
R¹ represents a hydrogen atom or a methyl group;
R² represents a hydrogen atom or an alkyl group comprising from 1 to 3 carbon atoms;
X represents a bisphenol A unit;
n is an integer ranging from 1 to 10.

The abovementioned bisphenol A unit corresponds to a unit of formula:

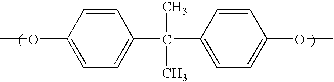

Epoxy vinyl ester resins which are particularly advantageous in the context of this invention are:
bis-GMA or 2,2-bis(4-(2-hydroxy-3-methacryloyloxy-propoxy)phenyl)propane, corresponding to the following formula: 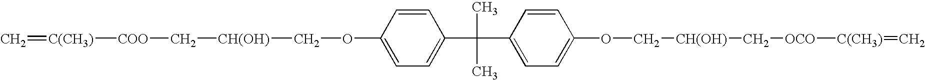
ethoxylated bisphenol dimethacrylate, corresponding to the general formula: 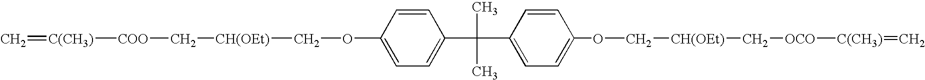
with Et representing an ethyl group.

The resins of this invention may be available commercially from the suppliers Cray Valley, UCB and Sigma-Aldrich.

The epoxy vinyl ester resins of the present invention can also be easily prepared as is mentioned above by reaction of an epoxy resin with an acrylic or methacrylic acid, optionally followed by an alkylation reaction on the —OH functional groups present.

Preferably, the epoxy vinyl ester resins are present in the composition at a content ranging from 18 to 50% by weight with respect to the total weight of the composition.

The presence of at least one epoxy vinyl ester resin in the composition contributes to conferring thereon a reduction in shrinkage on curing and a reduction in water absorption.

As mentioned above, the composition of the invention also comprises at least one urethane acrylate resin.

Urethane acrylate resins are resins resulting from the reaction of an isocyanate compound (for example a diisocyanate or triisocyanate compound) with an —OH group of an acrylate or methacrylate monomer.

Advantageous urethane acrylate resins of the invention can be represented by the following general formula: 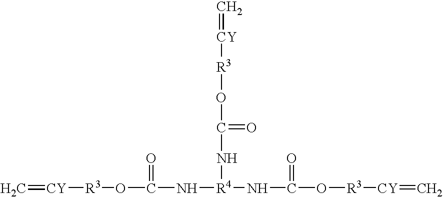
in which
R³ represents a group of formula —CH₂—(CH₂)ₙ—O—CO— with n being an integer equal to 1 or 2;
Y represents H or —CH₃;
R⁴ represents an alkylene group comprising from 1 to 10 carbon atoms.

Urethane acrylate resins which are particularly advantageous in the context of the invention may be commercial resins, such as those available from Cray Valley under the names CN945A60 and CN934.

These resins can also be prepared, as is mentioned, by reaction of an isocyanate compound with an —OH group of an acrylate or methacrylate monomer.

An appropriate isocyanate compound can be the compound corresponding to the formula below:

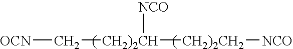

Appropriate acrylate or methacrylate monomers can be chosen, for example, from those of formulae:

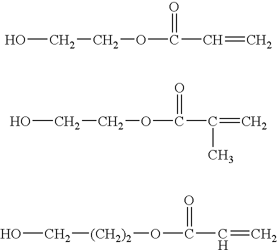

Preferably, the urethane acrylate resins are present in the composition at a content ranging from 1 to 50% by weight with respect to the total weight of the composition.

The presence of at least one urethane acrylate resin in the composition contributes to conferring thereon high stiffness and high viscosity, as well as a low water absorption.

The composition of the invention also comprises a non-silicone organic particulate filler.

It is specified that, previously and subsequently, the term “non-silicone organic particulate filler” is understood to mean a filler comprising exclusively organic compounds, namely compounds based on carbon and hydrogen, and optionally nitrogen, oxygen and fluorine, but devoid of silicon, said filler being in the form of solid particles. This filler must exhibit specific characteristics which confer on the composition high malleability, a degree of elasticity and a stiffness for its own weight, an improvement in the stability of the composition and a reduction in the tacky aspect of the abovementioned resin.

For this, the non-silicone organic particulate filler of the invention exhibits a mean particle size (that is to say a mean diameter) of less 10 μm, preferably of 2 to 7 μm, and a specific surface of greater than 10 m²/g, preferably from 15 to 25 m²/g.

This filler is preferably unreactive, that is to say that it does not comprise groups capable of curing during the photocuring of the composition.

Advantageously, this filler can be chosen from particulate polymers of the group consisting of polyamides, polyacrylates, such as poly(methyl methacrylate) (PMMA), optionally fluorinated polyolefins, such as polytetrafluoroethylene (PTFE), and polysaccharides, such as starch.

It is understood that the abovementioned polymers are in the form of powders exhibiting the abovementioned characteristics.

A particularly advantageous polyamide is a polyamide supplied by Atofina under the name Orgasol 2001 UD NAT2, this polyamide exhibiting a mean particle size of 5 μm and a specific surface of approximately 20 m²/g. This polyamide exhibits in particular excellent mechanical properties, such as a tensile strength of 48 MPa and an elongation at break of 5%.

A PMMA which can be used very advantageously in the context of this invention can be that supplied by Atoglas, UCB, which exhibits a mean particle size ranging from 5 to 10 μm and a specific surface of 12 m²/g. This PMMA exhibits in particular a tensile strength of 62 MPa and an elongation at break of 2.5%.

A PTFE which can be used very advantageously in the context of this invention is that supplied by Goodfellow, which exhibits a mean particle size ranging from 2 to 4 μm and a specific surface of 35 m²/g. This PTFE exhibits in particular a tensile strength of 35 MPa and an elongation at break of greater than 100%.

Polysaccharides which can advantageously be used are the soluble starch supplied by VWR.

Preferably, the non-silicone particulate filler of the composition is present in the composition at a content ranging from 10 to 25% by weight with respect to the total weight of the composition.

The composition according to the invention also comprises one or more photoinitiators, said photoinitiators being entities which release reactive entities on photolysis. To be specific, in the context of this invention, these photoinitiators are capable, after photolysis, of releasing free radicals.

Photoinitiators in accordance with the present invention can be aromatic ketones, such as benzophenone or thioxanthone, with the formulae represented below:

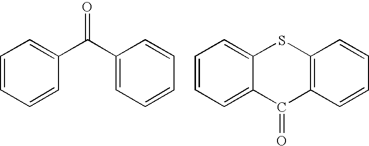

Photoinitiators which are particularly effective in the context of this invention can also be initiators of bisacylphosphine oxide type (said to be of BAPO type), such as the photoinitiator Irgacure 819 sold by Ciba, represented by the following formula:

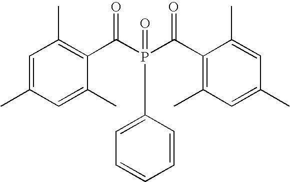

This photoinitiator exhibits the advantage of decomposing, under the action of UV light, to give four free radicals which can each initiate the crosslinking of the composition of the invention and makes it possible to greatly accelerate the rate of curing in coMParison with conventional photoinitiators, which only decompose to give 1 or 2 free radicals under the action of UV light.

Other particularly effective photoinitiators are also those corresponding to the formulae represented below:

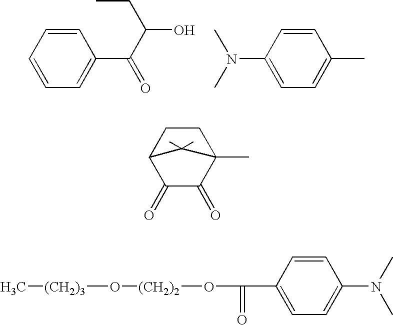

Preferably, the photoinitiator is present in the composition at a content ranging from 0.1 to 2% by weight with respect to the total weight of the composition.

Advantageously, the composition according to the invention can additionally comprise an elastomeric compound or an elastomeric composition, such as that sold by Ugine Dentaire under the name Plastiform®.

It is specified that, previously and subsequently, the term “elastomeric compound” or “elastomeric composition” is understood to mean a polymeric compound or a polymeric composition exhibiting a glass transition temperature of between 20 and 70° C.

Mention may be made, among the elastomeric compounds capable of advantageously participating in the composition of the invention, of (ethylene/vinyl acetate) copolymers or (hexafluoropropylene/vinylidene fluoride) copolymers.

The elastomeric compound and/or the elastomeric composition is (are) advantageously present in the composition at a content ranging from 20 to 60% by weight with respect to the total weight of the composition.

The presence of an elastomer in the composition contributes to improving its resistance under the effect of its weight, that is to say the ability of this composition to retain its shape after a deformation.

Advantageously, so as to have a composition exhibiting mechanical properties which are further improved, the composition of the invention can also comprise at least one, preferably crosslinked, polyester resin.

According to the invention, the term “polyester resin” is understood to mean a resin resulting from the reaction of an anhydride compound with a diol.

An appropriate polyester resin can be a resin comprising, after curing, the unit of following formula: 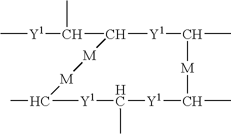
in which:
M is a unit resulting from a styrene or acrylate monomer;
Y¹ represents a group of formula:
   —CO—O—CH₂—CH(CH₃)—O—CO—

An example of a specific polyester resin is that for which M corresponds to the formula:

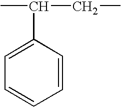

Appropriate polyester resins are available in particular from Gazechim, under the name Norsodyne, from Dow Plastics or from BASF.

In order to reduce the tacky properties of the composition of the invention, it is advantageously possible to incorporate in the latter at least one oil, preferably a non-silicone oil. This oil can be a vegetable oil or a synthetic oil, such as the oils with the Voltalef® trade mark corresponding to the general formula:
Cl—(CF₂—CFCl)ₙ—Cl
with n being an integer ranging from 3 to 4.

The oil is preferably present in the composition at a content ranging from 0.5 to 3% by weight with respect to the total weight of the composition.

The composition can also comprise one or more reactive solvents, that is to say solvents capable of dissolving the resins while being capable of reacting during the photocuring.

The reactive solvent can be chosen from the solvents corresponding to one of the following formulae: 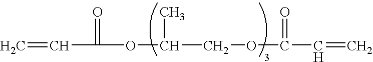
tripropylene glycol diacrylate (TPGDA) 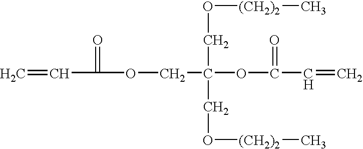
propoxylated 2-neopentyl glycol diacrylate (PONPGDA) and the mixtures of these.

The content of reactive solvent can be from 40 to 80% by weight of that of the epoxy vinyl ester or urethane acrylate resins.

The compositions of the invention can be used in numerous fields. Thus, they can be used for the preparation of calcinable patterns and molded components for numerous applications.

In particular, the compositions of the invention can be used in the dental field.

Thus, another subject matter of the invention is the use of a composition as described above for the manufacture of a dental prosthesis preform and/or of a dental prosthesis pattern, more particularly of a movable joined dental prosthesis.

It is specified that, previously and subsequently, the term “preform” is understood to mean a design produced with the composition of the invention, said design being intended to define the structure of future fixed or removable prostheses. For example, a preform can be a typical component of a removable dental prosthesis, such as the plate, clasps or bars. This preform serves as basis for the dental technician in producing a pattern of the future dental prosthesis, the pattern corresponding to the combination of the abovementioned assembled preforms. The technician can add appropriate additional components to the pattern, for example made of wax, such as replacement teeth. Once the pattern has been finalized, it is photocured in order to retain its modeled shape.

Thus, the invention also relates to a preform and/or a pattern based on a photocurable composition as described above.

Such a pattern can be prepared by a process comprising the following steps:
a step of taking an impression, carried out by applying an appropriate material to a buccal part to be provided with a prosthesis, so as to obtain an impression of said buccal part;
a step of preparing a plaster model, consisting in pouring plaster into the impression prepared above;
a step of modeling the desired pattern on the plaster model with the photocurable composition as described above;
a step of photocuring said pattern;
a step of separating said pattern, thus photocured, from the plaster model.

As mentioned above, this pattern serves as basis for the preparation of a dental prosthesis.

Thus, another subject matter of the invention is a process for the preparation of a dental prosthesis successively comprising:
the use of the process described above for the preparation of the pattern;
a step of investing said pattern in a cylinder, on conclusion of which an investment mold of the dental prosthesis is obtained;
a step of calcining said pattern;
a step of filling the investment mold with a molten metal or metal alloy, followed by cooling, so as to solidify the metal or metal alloy;
a step of destroying the investment mold, so as to release the dental prosthesis.

The step of taking the impression, the preliminary step in the preparation of the pattern, consists in reproducing in negative the buccal part to be provided with a prosthesis, so as to obtain an impression of this part. More specifically, this step consists in interposing, in the buccal cavity, for example, an impression tray, that is to say a device of suitable shape comprising the impression material. This impression material is a rapid-setting material, that is to say a material which has the ability, after molding, to harden at ambient temperature. Such materials can be chosen, for example, from alginates or hydrocolloids.

This impression serves as basis for the preparation of a plaster model which corresponds to the master model, said master model being prepared by pouring plaster into the abovementioned impression.

By virtue of the properties inherent in the compositions of the invention (namely malleability and elasticity), these compositions can be applied directly to the master model in order to constitute the pattern of the dental prosthesis. This modeling step consists, more specifically, in forming, on the master model, the precursor components (or preforms) of the future prosthesis, namely, for example, the base plate, the clasps or the possible bars, which will constitute, for example, the future framework of the prosthesis, the assembled product of these preforms constituting a pattern of the future dental prosthesis. Once modeling is complete, the compounded pattern is photocured during a photocuring step, it being possible for said step to take place as the constituent components of the pattern are constructed or on conclusion of the preparation of the pattern.

More specifically, this photocuring step can be carried out by subjecting the components formed from the compositions of the invention to UV light, for example supplied by a UV lamp emitting light with a wavelength ranging from 400 to 500 nm.

Once photocuring is complete, the pattern, thus photocured, is separated from the plaster model. This pattern exhibits the distinguishing feature of retaining, after said separation, its starting shape (namely the shape established on the plaster model) due to the elastic properties of the photocurable compositions of the invention.

This pattern serves as basis for the preparation of the dental prosthesis.

It is specified that this pattern can optionally be completed by fashioning appropriate components on the latter made of materials such as wax, it being possible for said components to be, for example, replacement teeth.

The process for preparing the dental prosthesis according to the invention comprises, as mentioned above, the use of the process, as set out above, for preparing a pattern.

The pattern is subsequently subjected to an investment step in a cylinder, said step consisting in covering the material of the pattern with investment material. On conclusion of this investment step, an investment mold of the dental prosthesis is obtained, this mold matching the shape of the pattern.

It is specified that the term “investment material” is understood to mean, previously and subsequently, a refractory molding material.

The process comprises, after the investment step, a step of calcining the pattern. More specifically, this step consists in heating, at an appropriate temperature, the assembled product composed of the investment mold and of the pattern based on photocurable composition of the invention. This temperature is chosen so as to calcine the pattern, it being possible for this temperature to be a temperature of 1000° C. under air.

On conclusion of this step, the photocurable composition of the invention, because of its calcinable nature, has disappeared without leaving any residues and only the investment mold of the dental prosthesis remains.

This investment mold is subsequently filled with a molten metal, preferably a noble metal (such as Ag, Pd or Pt), or a molten metal alloy, such as an alloy based on chromium, cobalt or titanium. After cooling, accompanied by solidification of said metal or alloy, the investment mold is destroyed, for example by spliting, so as to release the metal dental prosthesis.

By virtue of the use of the photocurable compositions of the invention, the process for preparing a dental prosthesis of the invention proves to be faster and cheaper than conventional processes, such as that set out in the state of the prior art part of the present description.

This is because the use of the compositions according to the invention to prepare a dental prosthesis pattern makes it possible to dispense with two conventional steps of processes for the preparation of dental prostheses, namely the step of taking a gelatin or silicone impression by countermolding the plaster model and the step of preparing an investment model by pouring the investment material into the gelatin or silicone impression. Consequently, by virtue of the invention, a considerable saving in time and also a reduction in the consumption of investment material are achieved.

Furthermore, the fact of placing only the pattern based on a composition of the invention in the cylinder for the investing makes it possible to obtain a consequent saving in space in this cylinder in comparison with the investing operations carried out conventionally starting from a pattern generally made of wax modeled on an investment model. By virtue of the saving in space obtained, it is thus possible, according to the invention, to carry out the simultaneous investing of several patterns in the same cylinder.

The invention will now be described with reference to the following examples given by way of illustration and without implied limitation.

### DETAILED ACCOUNT OF SPECIFIC EMBODIMENTS

The compositions presented below and in accordance with the invention are compositions exhibiting the following criteria:
a low shrinkage (<1%) after photocuring;
a tensile strength of between 10 and 100 MPa while having an elongation at break of approximately 5%;
a high viscosity, to facilitate the use, in the form of a paste, for modeling the desired preforms;
a degree of shape memory or intrinsic stiffness;
a low tackiness before photocuring;
a degree of calcination of 100% at 1000° C. under air;
an elastic nature.

### EXAMPLE 1

A photocurable composition in accordance with the invention exhibiting the abovementioned characteristics comprises the following components:

| | |
|---|---|
| Epoxy vinyl ester resin, CN104 | 25% |
| Urethane acrylate resin, CN934 | 10% |
| Polyamide 12, Orgasol | 9.7% |
| Initiator, Irgacure | 0.3% |
| Elastomer, Escorene | 55% |

### EXAMPLE 2

A photocurable composition in accordance with the invention exhibiting the abovementioned characteristics comprises the following components:

| | |
|---|---|
| Epoxy vinyl ester resin, CN104 | 35.9% |
| Urethane acrylate resin, CN934 | 24.0% |
| Oil, Voltalef ® | 2.0% |
| Polyamide 12, Orgasol | 10.5% |
| Polyester resin, Norsodyne G703 | 10.0% |
| Photoinitiator, Irgacure 819 | 0.1% |

### EXAMPLE 3

A photocurable composition in accordance with the invention comprises the following constituents:

| | |
|---|---|
| Epoxy vinyl ester resin, CN104 | 52.5% |
| Urethane acrylate resin | 22.5% |
| Oil, Voltalef ® 1S | 10.2% |
| Polyamide 6, Orgasol | 10.5% |
| Cellulose, Whatman | 4.0% |
| Photoinitiator, Irgacure 819 | 0.3% |

### EXAMPLE 4

A photocurable composition in accordance with the invention comprises the following components:

| | |
|---|---|
| Epoxy vinyl ester resin, CN104 | 37.0% |
| Urethane acrylate resin, CN934 | 6.9% |
| Vegetable oil | 2.4% |
| TPGDA* | 24.7% |
| Soluble starch, Prolabo | 25.2% |
| Cellulose acetate, Whatman | 3.7% |
| Photoinitiator, Irgacure | 0.1% |

*Tripropylene glycol diacrylate

### EXAMPLE 5

A photocurable composition in accordance with the invention comprises the following components:

| | |
|---|---|
| Epoxy vinyl ester resin, CN104 | 39.0% |
| Urethane acrylate resin, CN934 | 6.5% |
| Plastiform | 27.4% |
| Orgasol 2001 UD NAT2 | 26.5% |
| Photoinitiator, Irgacure | 0.6% |

1-28. (canceled)

29. A photocurable composition comprising:
at least one epoxy vinyl ester resin;
at least one urethane acrylate resin;
at least one non-silicone organic particulate filler exhibiting a mean particle size of less than 10 μm and a specific surface of greater than 10 m²/g; and
at least one photoinitiator.

30. The photocurable composition of claim 29, in which the epoxy vinyl ester resin corresponds to the formula: 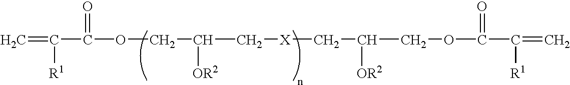
in which:
R¹ represents a hydrogen atom or a methyl group;
R² represents a hydrogen atom or an alkyl group comprising from 1 to 3 carbon atoms;
X represents a bisphenol A unit;
n is an integer ranging from 1 to 10.

31. The photocurable composition of claim 29, in which the epoxy vinyl ester resin is chosen from the resins with the following formulae:

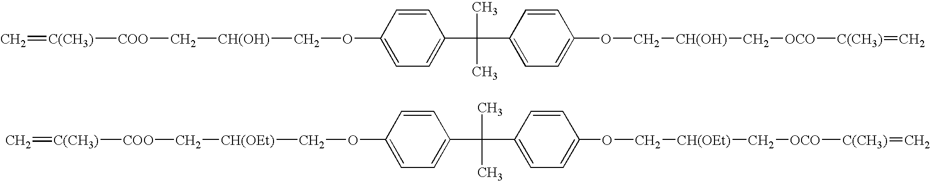

32. The photocurable composition of claim 29, in which the epoxy vinyl ester resin is present in the composition at a content ranging from 18 to 50% by weight with respect to the total weight of the composition.

33. The photocurable composition of claim 29, in which the urethane acrylate resin corresponds to the following general formula: 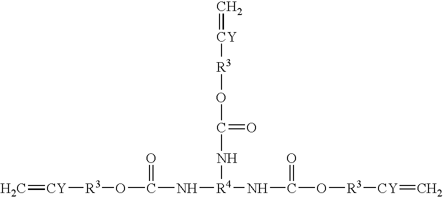
in which
R³ represents a group of formula
—CH₂—(CH₂)ₙ—O—CO— with n being an integer equal to 1 or 2;
Y represents H or —CH₃;
R⁴ represents an alkylene group comprising from 1 to 10 carbon atoms.

34. The photocurable composition of claim 29, in which the urethane acrylate resin is present in the composition at a content ranging from 1 to 50% by weight with respect to the total weight of the composition.

35. The photocurable composition of claim 29, in which the non-silicone organic particulate filler is chosen from particulate polymers of the group consisting of polyamides, polyacrylates, optionally fluorinated polyolefins, and polysaccharides.

36. The photocurable composition of claim 29, in which the non-silicone organic particulate filler is present in the composition at a content ranging from 10 to 25% by weight with respect to the total weight of the composition.

37. The photocurable composition of claim 29, in which the photoinitiator is chosen from aromatic ketones and bisacylphosphine oxide compounds.

38. The photocurable composition of claim 37, in which the photoinitiator corresponds to aromatic ketones corresponding to the following formulae:

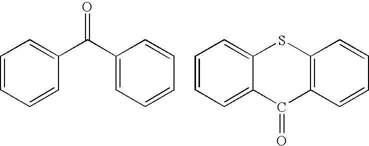

39. The photocurable composition of claim 37, in which the photoinitiator corresponds to a bisacylphosphine oxide compound of following formula:

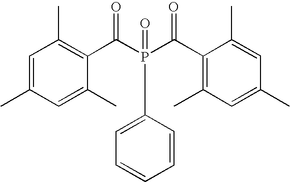

40. The photocurable composition of claim 29, in which the photoinitiator corresponds to one of the following formulae:

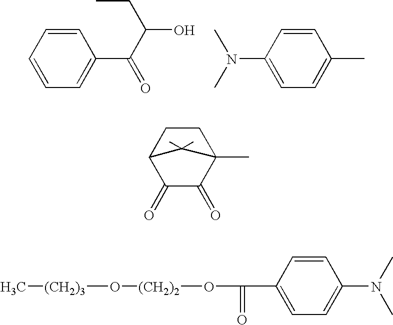

41. The photocurable composition of claim 29, in which the photoinitiator is present in the composition in a content ranging from 0.1 to 2% by weight with respect to the total weight of the composition.

42. The photocurable composition of claim 29, additionally comprising at least one elastomeric compound and/or one elastomeric composition.

43. The photocurable composition of claim 42, in which the elastomeric compound is a compound chosen from (ethylene/vinyl acetate) copolymers or (hexafluoropropylene/vinylidene fluoride) copolymers.

44. The photocurable composition of claim 42, in which the elastomeric compound and/or the elastomeric composition is (are) present in the composition at a content ranging from 20 to 60% by weight with respect to the total weight of the composition.

45. The photocurable composition of claim 29, additionally comprising at least one polyester resin.

46. The photocurable composition of claim 29, additionally comprising at least one oil.

47. The photocurable composition of claim 46, in which the oil is a non-silicone oil.

48. The photocurable composition of claim 46, in which the oil is an oil of formula:
Cl—(CF₂—CFCl)ₙ—Cl
with n being an integer ranging from 3 to 4.

49. The photocurable composition of claim 46, in which the oil is present in the composition at a content ranging from 0.5 to 3% by weight with respect to the total weight of the composition.

50. The photocurable composition of claim 29 additionally comprising at least one reactive solvent.

51. The photocurable composition of claim 50, in which the reactive solvent is chosen from the solvents corresponding to one of the following formulae: 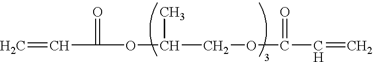
tripropylene glycol diacrylate (TPGDA) 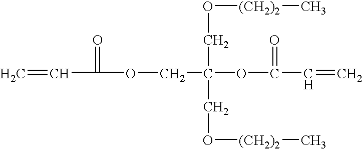
propoxylated 2-neopentyl glycol diacrylate (PONPGDA) and the mixtures of these.

52. The use of a photocurable composition as claimed in claim 29 in the manufacture of a dental prosthesis preform and/or of a dental prosthesis pattern.

53. A dental prosthesis preform based on a photocurable composition as claimed in claim 29.

54. A dental prosthesis pattern based on a photocurable composition as claimed in claim 29.

55. A process for the preparation of a dental prosthesis pattern comprising the following steps:
a step of taking an impression, carried out by applying an appropriate material to a buccal part to be provided with a prosthesis, so as to obtain an impression of said buccal part;
a step of preparing a plaster model, consisting in pouring plaster into the impression prepared above;
a step of modeling the desired pattern on the plaster model with the photocurable composition as defined in claim 29;
a step of photocuring said pattern;
a step of separating said pattern, thus photocured, from the plaster model.

56. A process for the preparation of a dental prosthesis, comprising:
the use of the process as claimed in claim 55 for the preparation of the pattern;
a step of investing said pattern in a cylinder, on conclusion of which an investment mold of the dental prosthesis is obtained;
a step of calcining said pattern;
a step of filling the investment mold with a molten metal or metal alloy, followed by cooling, so as to solidify the metal or metal alloy;
a step of destroying the investment mold, so as to release the dental prosthesis.
